(19) United States
(12) Patent Application Publication
(10) Pub. No.: US 2006/0213954 A1
(43) Pub. Date: Sep. 28, 2006

(54) Method and joining element for joining workpieces

(76) Inventors: Michael Ruther, Rottenburg-Heilfingen (DE); Sven Dickes, Sindelfingen (DE); Virginio Buonaccorso, Sindelfingen (DE); Gerson Meschut, Bielefeld (DE); Torsten Draht, Bielefeld (DE)

Correspondence Address: SEYFARTH SHAW LLP, 55 E. MONROE STREET, SUITE 4200, CHICAGO, IL, 60603-5803, US

(21) Appl. No.: 11/387,478

(22) Filed: Mar. 23, 2006

(30) Foreign Application Priority Data
Mar. 23, 2005 (DE) 10 2005 013 568.4

(51) Int. Cl. B23K 20/12; B23K 31/02; B23K 37/00

(52) U.S. Cl. 228/113; 228/112.1; 228/114.5; 228/2.3

(57) ABSTRACT

A method for joining at least two workpieces in abutment to each other by a joining element. The joining element 6 is driven so as to perform rotational and translational movements in order to be moved through the upper workpiece 2 and into the lower workpiece 4 without full penetration of the lower workpiece in order to provide for an integral one-piece joint between the joining element and the lower workpiece due to friction as a result of said rotational and translational movements. The joining process will result further in a joint between the joining element and the upper workpiece which is mainly a positively interlocking and/or friction joint. The workpieces remain in engagement to each other and are being interconnected. The method enables to join workpieces 2, 4 not only of similar but also of different materials such as aluminium/steel or plastic material/metal. Generally it is sufficient that the joining area is accessible only from one side.

### BACKGROUND OF THE INVENTION

The present invention relates to a method for joining at least two workpieces by a joining element.

It is quite often necessary to join workpieces in joining areas where the workpieces are accessible only from one side. Many joining techniques such as self-piercing riveting and clinching are not suitable for this purpose. While there are joining techniques such as joining by blind rivets and screws which allow joining the workpieces from only one side thereof, the joining techniques usually require special measures such as boring holes, deformation of the blind rivet, forming of threads, etc.

DE 196 30 271 C2 discloses a method for joining a workpiece of plastifiable material to another workpiece where a friction element is moved through an upper workpiece into a lower workpiece to generate a plastified process zone and to move such plastified process zone into the area between the two workpieces. Thereafter the friction element is withdrawn in order to provide a spin welding joint of the workpieces in the area of a gap between the two workpieces. This joining method is said to allow for joining of workpieces of different materials such as steel and aluminium. Because this joining technique does not use a joining element remaining in the workpieces, the strength of the joint relies on a relatively small spin welding zone between the workpieces.

DE 197 31 638 A1 discloses a similar joining method wherein a rotating friction pin penetrates into the upper workpiece without fully penetrating therethrough. In the area of the joining zone the workpieces are urged against each other by the force of the friction pin and axial fixing of the lower workpiece in order to provide for a temperature increase by friction and pressure in the area of the joining zone so as to join the workpieces by “microdeformations” similar to the mechanism of pressure welding. In this method the pin may be withdrawn after the joining process or may remain as a unit on the workpiece connection. Apart therefrom that this joining technique requires the joining zone to be accessible from both sides of the workpieces, the strength of the joint is limited again to the strength of the “press-joining zone”.

The article “Untersuchungen zur Anwendbarkeit des Reibbolzenschweiβens” in the periodical “Schweiβen und Schneiden”, 1994, No. 7, pages 319-324 describes a so-called friction pin welding method wherein a pin is welded vertically to the upper surface of a metal sheet similar to electric arc welding. This method uses the friction heat generated by a pin rotating on the metal sheet under an axial force. The pin may be made from aluminium, and the metal sheet may be made from steel. When the pin is positioned and rotated upon the metal sheet some abrasion of the pin will result; the abraded material is displaced from the welding zone so as to form a closed welding bead. As a result the length of the pin is reduced, which is necessary to enter sufficient energy into the workpieces.

As a special application the article mentions a so-called “through-welding technique” for fixing thin aluminium sheets to steel structures where the friction pin made of steel is moved through the aluminium sheet and is welded to the upper surface of the steel structure. The welding bead generated by the welding process combines with displaced material of the friction pin. The friction bead and the “interlinked” material of the friction pin are positioned between the aluminium sheet and the steel structure so that these members are spaced from each other by a certain distance.

DE 196 20 814 A1 discloses a method of joining two workpieces wherein a joining element is driven to perform rotational and translational movements through the upper workpiece and into the lower workpiece without fully penetrating through the lower workpiece. The melted material generated by the joining process flows into the gap between the two workpieces to provide for a welding connection between the two workpieces. A corresponding welding connection will result also between the joining element and the two workpieces. The joining element is of a substantially circular cross section and has a tapering end portion in the shape of an obtuse cone and a following cylindrical or also conical intermediate portion with the cone angle of the end portion substantially exceeding the cone angle of the intermediate portion. In one embodiment the end portion is provided with a plurality of radially extending cutting edges. The intermediate portion is followed by an enlarged head which has its side remote from the end portion provided with depressions to receive a driving tool.

### SUMMARY OF THE INVENTION

It is a primary object of the present invention to provide a method and a joining element for joining at least two adjacent workpieces, with the joint being of high joining strength and excellent joining quality. The joining process is to be performed such that the workpieces remain in abutment to each other during and after the joining operation. Preferably the method of the present invention should be adapted to be usable for joining workpieces where the joining area is accessible only from one side of the workpieces.

In the method of the present invention a joining element is driven so as to perform rotational and translational movements through a first workpiece and into a second workpiece without fully penetrating the second workpiece. Friction generated by this joining process will result in an integral one-piece joint between the joining element and the second workpiece, in particular a spin welding joint by which the workpieces are joined to each other. During the joining process the workpieces remain in abutment to each other. At the same time a positive interlocking and/or friction joint between the joining element and the first workpiece will result. Furthermore a friction joint between the joining element and the second workpiece may be provided, and an integral one-piece connection between the joining element and the first element may be provided.

Since the workpieces are connected to each other by a separate joining element, a high joining strength and an excellent joining quality will result. The method of the present invention allows for joining of workpieces where the joining area is accessible only from one side. Since furthermore the workpieces do not need to be pre-treated, in particular not be provided with pre-manufactured holes, the method of the present invention is relatively simple and cost effective. A further advantage of the method of the present invention is that it allows for joining workpieces of different materials such as different metal combinations, in particular aluminium/steel or magnesium/steel, or other combinations such as plastic material/metal, in particular polymeric material/metal.

A further important advantage of the method of the present invention is that the workpieces after the joining operation are still in abutment to each other, i.e. that the workpieces are not urged apart by the joining operation. To this end the invention provides that the geometrical shape of the joining element and/or the materials of the joining element and of the workpieces and/or predetermined process parameters of the joining process are selected such that the workpieces remain in abutment to each other during the joining operation. As an alternative or as an additional measure the workpieces may be retained in abutment to each other during the joining process by a clamping device.

The joining element may be made of the same material as the second workpiece or of another material. In particular the joining element is made of a material such as metal (steel) which may combine with the second workpiece so as to form an integral one-piece joint.

As already mentioned pre-treatment of the workpieces and in particular boring a hole through the workpieces is not necessary so that the joining element displaces material of the first workpiece when it is being moved through the first workpiece. In this case it is preferred to use a joining element having an enlarged head which has its bottom surface provided with an annular groove or another recess for receiving displaced material of the first workpiece. As a result the molten material cannot flow, in an uncontrolled manner, into the interfaces between the joining element and the workpieces as well as between the workpieces. A joint of high strength, rigidity, and stability will result.

As an alternative, it is possible to provide the first workpiece with a hole at the joining area prior to the joining process, with the diameter of the hole exceeding the diameter of the joining element. This will result in a gap between the wall of the hole and the joining element, which gap may receive displaced material of the second workpiece.

In accordance with a further preferred embodiment of the present invention the joining element has a leading penetrating portion and a trailing body portion of cross-sectional areas increasing opposite to the direction of penetration. The surfaces of the penetrating portion and the body portion each include a constant or varying angle with a central axis of the joining element, with the maximal angle of the penetrating portion exceeding the minimal angle of the body portion. Preferably the surfaces of the penetrating and body portions of the joining elements are of conical shape which may be smooth or which may be provided with helical cutting edges.

### BRIEF DESCRIPTION OF THE DRAWINGS

With reference to the accompanying drawings preferred embodiments of the present invention will be described and explained in detail. In the drawings:

FIGS. 1 to 3 are schematic views of different steps of a joining operation for joining two workpieces by means of a joining element according to an embodiment of the present invention;

FIGS. 4 to 6 are views similar to FIG. 3 and showing a joint including modified joining elements;

FIG. 7 is a partially sectioned side view of a further embodiment of a joining element;

FIG. 8 is a perspective rear view of the joining element in FIG. 7;

FIGS. 9, 10 are perspective views of modified embodiments of the joining element in FIGS. 7, 8;

FIG. 11 is a partially sectioned view of a joint including a joining element according to FIGS. 7, 8 and a tool for setting the joining element;

FIG. 12 is a perspective view of the tool in FIG. 11 from below;

FIG. 13 is a partially sectioned side view of a joint including a joining element as in FIGS. 7, 8, with the upper workpiece being provided with a pre-manufactured hole.

### DETAILED DESCRIPTION OF PREFERRED EMBODIMENTS

With reference to FIG. 1, two plate-shaped workpieces 2, 4 in abutment to each other are to be joined by a joining element 6. As an example, the workpiece 2 is a frame member of steel (lower workpiece 4) which is to be “covered” by an aluminium sheet (upper workpiece 2).

The joining element 6 is, in the embodiment of FIG. 1, a rotationally symmetrical member comprising a conical body portion 8 and a conical penetrating portion 10 terminating in a tip. The body portion 8 is provided with a drive means 12 comprising a recess (e.g. a polygonal depression, a slot, a torx) as indicated by dotted lines.

For making the joint the joining element 6 is driven by drive means (not shown) so as to perform simultaneous rotational and translational movements as indicated by the arrows Fₐ and ω, whereby the tip of the conical penetrating portion 10 of the joining element 6 penetrates from above into the material of the workpieces 2, 4.

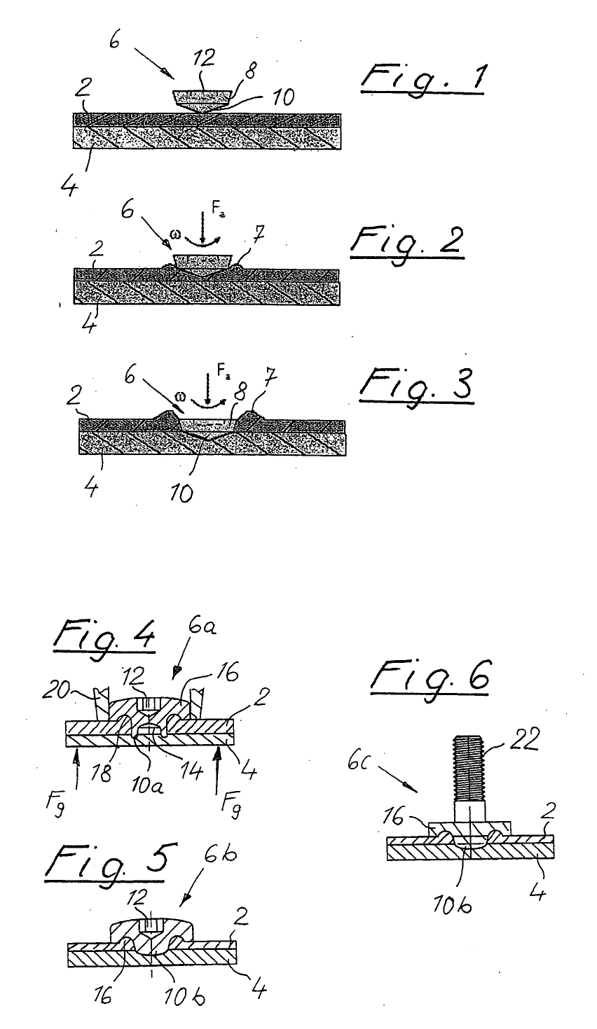

As shown in FIG. 2 the joining element 6 initially penetrates into the material of the upper workpiece 2. As a result the joining element 6 displaces material of the not pre-punched upper workpiece 2 toward the top surface of the workpiece 2 so that a corresponding material pile-up 7 comprising an annular projection will result on the top surface of the workpiece 2. While the joining element 6 continues to perform rotational and translational movements the joining element 6 penetrates into the lower workpiece 4 after having moved completely through the upper workpiece 2. The resultant friction in the joining element 6 and the lower workpiece 4 and the resultant heat cause material to plasticize; the plasticized material will cool down and harden so as to provide an integral one-piece joint, i.e. a spin welding joint between the joining element 6 and the lower workpiece 4 as indicated in FIG. 3.

In the embodiment shown in FIGS. 1 to 3, the joining element 6 is of a shape such that, at the end of the joining operation, the body portion 8 is fully received within the upper workpiece 2, and only the penetrating portion 10 extends into the lower workpiece 4. While the joining element 6 and the lower workpiece 4 are joined by an integral one-piece connection due to the spin welding operation, the joining element 6 and the upper surface 2 are connected by a positive interlocking joint due to the conical shape of the body portion 8; the positive interlocking joint is normally accompanied by a friction joint.

As a result the joining element 6 is connected to the upper workpiece 2 substantially by interlocking and frictional means and to the lower workpiece 4 substantially by plastified and hardened material.

Additionally, however, an integral one-piece connection between the joining element 6 and the upper workpiece 2 may be provided, and additionally, a friction connection between the joining element 6 and the lower workpiece 4 may be provided.

As shown in FIGS. 1 to 3 the workpieces 2, 4 remain in abutment to each other during the joining operation so that they abut each other in the final joint. This may be achieved by various measures as explained below:

One measure is selecting the geometrical shape of the joining element 6 such that the joining element penetrating into the lower workpiece 4 generates no or only an insignificant pile-up of material which otherwise could raise the upper workpiece 2 from the lower workpiece 4. Alternatively or additionally, the materials of the joining element and the workpieces may be selected such that any material pile-up which could urge the workpieces apart is avoided. When for example the material of the joining element 6 is relatively hard as compared to the materials of the workpieces and in particular the material of the upper workpiece 2, normally there will be no material pile-up. If nevertheless there will be a (relatively small) material pile-up, this material pile-up may penetrate into the relatively soft material of the upper workpiece 2. In each case this will prevent the workpieces 2 and 4 from being urged apart.

Another measure to retain the workpieces in abutment to each other is the use of specific process parameters of the joining process. The process parameters comprise in particular the speeds of the rotational and translational movements of the joining element 6, i.e. the rotational speed ω and the advance speed of the translational movement, as well as the joining force Fₐ as will be explained in more detail below.

Another measure to retain the workpieces 2, 4 in abutment to each other during the joining process is the use of a clamping device which will be explained in more detail with reference to FIG. 4.

Furthermore, the joining operation normally will result in a friction connection between the adjacent surfaces of the workpieces 2 and 4. Depending on the materials as used an adhesive connection between the workpieces 2 and 4 may be desirable to avoid contact corrosion between the workpieces.

As should be appreciated from the above description and the FIGS. 1 to 3, the joining operation requires access to the joining area only from one side of the workpieces. It should be noted, however, that the method of the invention may be used also in applications where the joining area is accessible from both sides of the workpieces as will be explained with reference to FIG. 4. The plasticized and hardened material connection between the joining element 6 and the lower workpiece 4 and the positive interlocking and/or plasticized and hardened material connection between the joining element 6 and the upper workpiece 2 will result in a joint of high strength and excellent quality. Since the workpieces 2 and 4 do not need to be pre-treated, in particular need not to be provided with pre-manufactured holes, making of the joint is relatively simple and inexpensive.

The method of the present invention allows to join workpieces of many different material combinations as long as the joining element 6 and the lower workpiece 4 can be joined by a connection formed by plasticized (fused) and hardened material. In particular the method of the present invention allows to join workpieces of different material types. In accordance with a particularly preferred embodiment of the invention the upper workpiece 2 is made of a relatively soft ductile material such as a thin metal sheet, and the lower workpiece 4 is made of a high-strength material of increased hardness which exhibits a substantially greater thickness than the upper workpiece 2. As already mentioned above, the workpieces 2, 4 can be made of different metals such as aluminium/steel or magnesium/steel, or of plastic material, in particular a polymeric plastic material, and metal.

The joining element 6 may be made of the same material as the lower workpiece 4 or another material. Preferably the joining element 6 is made of metal, in particular steel, which may combine with the material of the lower workpiece 4 by a desired spin welding connection.

The joining force Fₐ exerted upon the joining element 6 for causing the joining element to perform a translational movement may be relatively small and may be for example in the order of 2 to 5 kN and in particular in the order of 3 to 4 kN. The supporting capability of the workpiece assembly of the two workpieces 2 and 4, therefore, is generally sufficient to withstand the joining force Fₐ without requiring a support of the workpieces 2, 4 opposite to the joining force Fₐ, i.e. support on the bottom side of the lower workpiece 4.

The rotational speed ω of the rotation of the joining element 6 is to be selected so as to be high enough to generate friction heat necessary for the fusing operation. The rotational speed ω is preferably in the range of 5,000 to 30,000 rpm, preferably 10,000 to 25,000 rpm and in particular in the order of 23,000 rpm.

In FIGS. 1 to 3, the workpiece 2, 4 have not been pre-treated, in particular they have not been provided with pre-manufactured holes. However, it would be possible to provide the upper workpiece 2 with a pre-manufactured hole of a diameter similar to or smaller or larger than the diameter of the joining element 6. The shape of the hole could be similar to the shape of the respective body portion of the joining element. In this case no material of the upper workpiece 2 would be displaced. If the hole of the upper workpiece is smaller than the joining element 6, material would be displaced, however less than as shown in FIGS. 2 and 3.

The joining process can be performed in a single step or phase by driving the joining element such that the rotational movement and translational movement of the joining element will be simultaneous and will be terminated at the same time when the joining element has reached its final position within the workpieces 2, 4. As an alternative the joining element could be driven in a first phase so as to perform simultaneous rotational and translational movements and to abruptly terminate the rotational movement, and the joining element could be driven thereafter in an immediately following second phase so as to be moved into its final position within the lower workpiece 4 by a further translational movement (“post-pressing”). As an example the joining operation could be performed in the first phase under a joining force of 3 kN and during a period of 1,000 ms and in the second phase under a joining force of 4 kN and during a period of 300 ms. Such a two-step or two-phase operation will result in a high quality welding joint between the joining element 6 and the lower workpiece 4.

It should be understood that the joining element could be of other shapes than shown in FIGS. 1 to 3. In FIG. 4 the joining element 6a has a penetrating portion 10a in the form of a half-hollow shank including a central recess 14 similar to a self-piercing half-hollow rivet. The penetrating portion 10a is not provided with a tip but rather with an annular edge for piercing the upper workpiece 2 and for penetrating into the lower workpiece 4. The central recess 14 can receive material displaced during the joining operation.

Furthermore the joining element 6a is provided with an enlarged flange-like head 16 having a bottom side which is provided with a recess comprising an annular groove 18. The annular groove 18 may receive material of the upper workpiece 2 which is displaced during the joining operation so that such material will not project above the top surface of the workpiece 2. Therefore the flange-like head 16 is supported against the top surface of the workpiece 2 and not against the projection formed by displaced material. This allows to obtain increased stiffness and stability of the joint.

In FIG. 4, a clamping device 20 comprising a sleeve-shaped member is schematically indicated; the sleeve-shaped member of the clamping device exerts a clamping force upon the workpieces 2, 4 adjacent to the joining area in order to prevent the upper workpiece 2 from being raised above the lower workpiece 4. Preferably a counterforce F_{g} is exerted upon the lower workpiece 4 so as to oppose the clamping force. The joining element 6a shown in FIG. 4 is also provided with a drive means 12 comprising an internal polygonal depression. Of course the drive means could be of other designs such as an external polygonal surface, a torx, a slot or the like.

The joining element 6b shown in FIG. 5 substantially corresponds to the joining element 6a shown in FIG. 4 except that the penetrating portion 10b terminates in a massive radiused projection.

The joining element 6b shown in FIG. 6 differs from joining element 6b in FIG. 5 substantially by including a functional element 22 for performing an additional function. In the embodiment as shown the functional element 22 is a threaded bolt which may be used for mounting an additional structural member. In this case the joining element performs two functions, i.e. the function of joining the workpieces and the function of mounting an additional structural member. It should be understood that other functional elements such as a pin without threads may be provided.

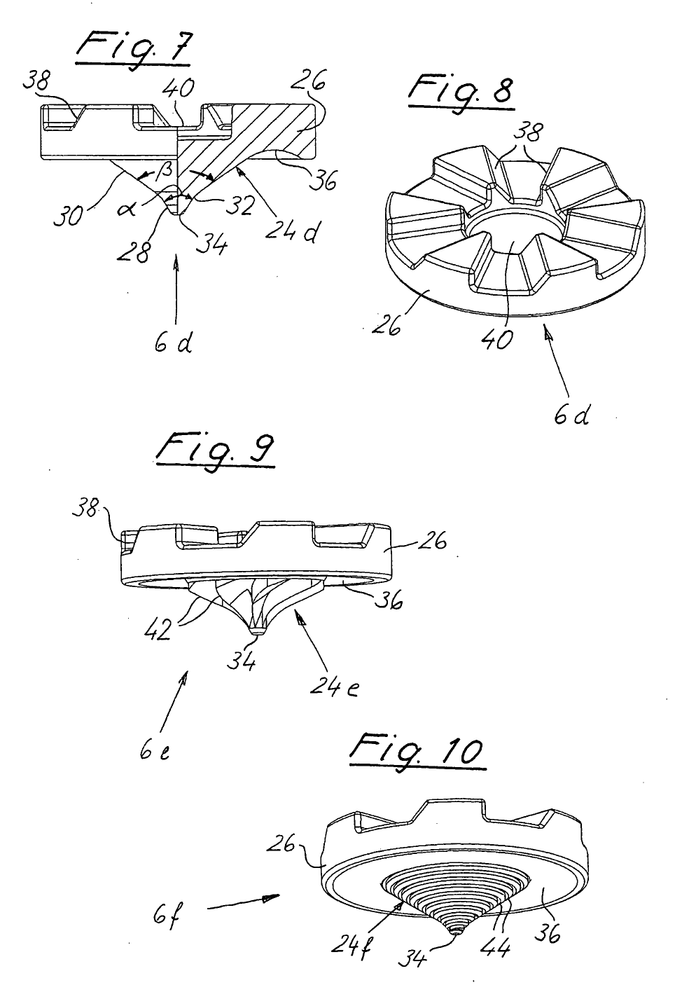

In FIGS. 7 and 8 the joining element 6d comprises a body 24d penetrating into the workpieces and a flange-like enlarged head 26. The body 24d comprises a penetrating portion 28 and a body portion 30 having a common central axis and being rotationally symmetrical with respect thereto.

Also in this embodiment the cross-sectional area of the penetrating portion 28 and the cross-sectional area of the body portion 30 increase in a direction opposite to the direction of penetration. In this embodiment, however, such increase of the cross-sectional areas of the penetrating portion 28 and of the body portion 30 is selected such that the penetrating portion 28 is more acute than the body portion 30. In other words, the penetrating portion 28 and the body portion 30 on the one hand and the central axis of the joining element include a constant (fixed) or varying angle such that the maximal angle of the penetrating portion 28 is smaller than the minimal angle of the body portion 30.

In the embodiment of FIGS. 7 and 8 the external surfaces of the penetrating portion 28 and of the body portion 30 are conical surfaces which are connected by a radiused surface.

The cone angle α of the penetrating portion 28 is substantially smaller than the cone angle β of the body portion 30. Preferably the cone angle α of the penetrating portion 28 is in a range between 40° and 100°, in particular in the order of 60° and the cone angle β of the body portion 30 is preferably in the range between 90° and 170°, in particular in the order of 150°. The radiused surface 32 has a radius which is preferably in the range of 1.0 to 3.0 mm, in particular in the order of 1.5 mm.

The penetrating portion 28 merges into a tip 34 which may be sharp or radiused.

An advantage of this embodiment of the joining element 6d is that the relatively narrow and acute penetrating portion 28 induces friction and performs a centering function. The relatively flat shape of the body portion 30 enhances flow of plasticized (molten) material in an outwards direction.

The head 26 of the joining element 6d has its bottom surface provided with an annular groove 36 which may receive material of the upper workpiece 2 which has been plasticized and displaced during the joining operation. On its side remote from body 24d the head 26 is provided with teeth 38 serving as drive means, and a central hole 40 the purpose of which will be explained below.

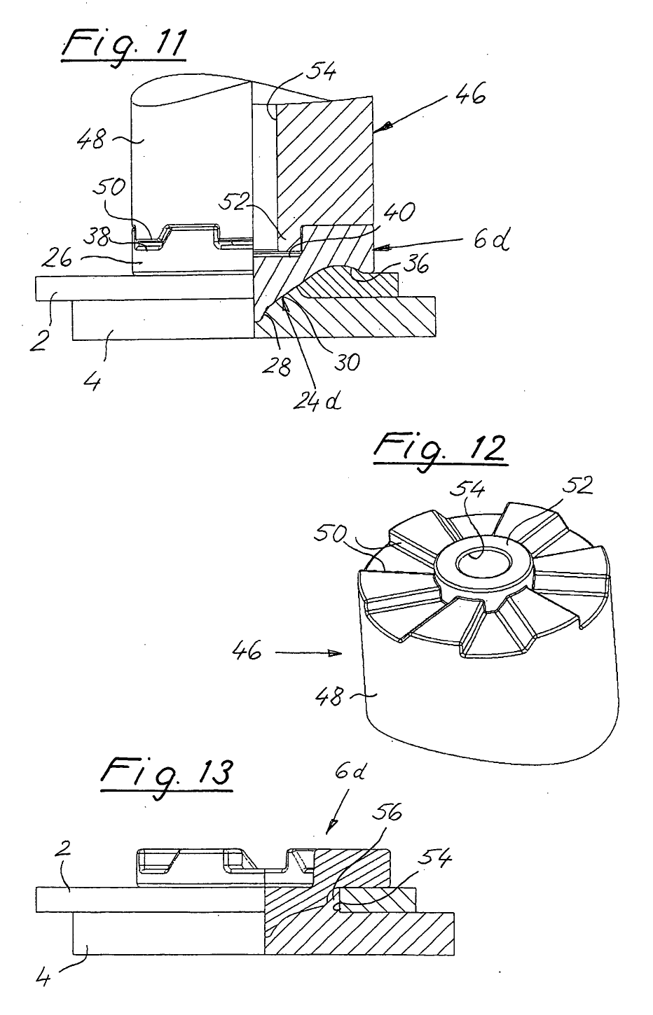

The joining element 6e shown in FIG. 9 substantially corresponds to that of FIGS. 7 and 8 except that the penetrating and body portions of the body 24e have their external surfaces provided with circumferentially spaced helical cutting edges 42. The pitch angle of the cutting edges 42 has been selected such that helical “vanes” similar to the vanes of a fan will result as shown in FIG. 9. The helical “vanes” merge into the radiused tip 34.

The helical cutting edges 42 of the joining element 6e form some kind of boring or milling tip which when it penetrates into the upper workpiece does not perform a frictional action but rather a machining action. When for example the upper workpiece 2 is made of aluminium or an aluminium alloy and the lower workpiece 4 is made of steel, the “boring or milling tip” of the joining element 6e avoids “smearing” of the aluminium material. When thereafter the “boring or milling tip” engages the steel of the lower workpiece 4, the friction or spin welding process begins. The aluminium material will then be received and enclosed in the gaps between the cutting edges 42. Excess material may be received in the annular groove 36 of the head 26.

This allows to obtain a joint of high quality and excellent strength and stability.

The joining element 6f in FIG. 10 substantially corresponds to that in FIG. 9 except that the body portion 24f is provided with a single helical cutting edge 44 instead of a plurality of helical cutting edges 42. The pitch angle of the cutting edge 44 is chosen such that the cutting edge 44 will be of helix or worm shape having a plurality of circumferentially extending turns.

Operation of the joining element 6f in FIG. 10 is similar to that of the joining element 6e in FIG. 9. Also in this case the cutting edge 44 of the body 24f of the joining element 6f performs a machining function; the aluminium chips resulting therefrom enter into the helix-shape gap between the turns of the cutting edge 44 and are conveyed outwards. Also in this case a joint of high strength and stability will result.

In both embodiments of FIGS. 9 and 10 the virtual envelope of the cutting edge 42 and 44 is in the shape of the external surface of the body 24d of the joining element 6d in FIGS. 7 and 8. It should be understood that the shape of the virtual envelope could be selected otherwise provided that the cross-sectional area of the envelope increases from the tip 34 towards the flange-like head 26.

FIG. 11 shows a final joint between a joining element 6d as shown in FIGS. 7 and 8 and two workpieces 2, 4, and a feed and drive tool 46. As shown the body 24d of the joining element 6d including the penetrating portion 28 and the body portion 30 have penetrated into the workpieces 2, 4; the head 26 lies upon the top surface of the workpiece 2, and the plasticized (molten) and displaced material of the workpiece 2 has flown into the annular groove 36 of the head 26. The volume of the annular groove 36 is preferably chosen such that it is substantially filled by the excess molten material. The resulting joint provides for optimal contact between the joining element 6d and the workpieces 2, 4 as well as between the workpieces 2 and 4. This enhances further the quality and strength of the joint.

The feed and drive tool 46 comprises a tube-shaped tool member 46 having a free end provided with teeth 50 and an annular projection 52. The teeth 50 and the annular projection 52 are matingly shaped with respect to the teeth 38 and the hole 40 of the joining element 6d. Furthermore the tool 46 is provided with a central bore 54.

When the teeth 50 and the annular projection 52 of the tool 46 engage into the teeth 38 and the hole 40 of the joining element 6d, the joining element 6d is retained on the tool 46 by vacuum supplied through the bore 54. As a result the tool 46 can be used to feed the joining element 6d to the joining area and to drive the joining element 6d so that it penetrates into the workpieces 2, 4. This allows to initiate rotation of the joining element 6d already before the joining element 6d will contact the workpieces 2, 4.

As mentioned above the method of the present invention preferably is used to join workpieces (metal sheets) which are not provided with pre-manufactured holes. In contrast thereto FIG. 13 shows an embodiment wherein the upper workpiece 2 has been provided with a pre-manufactured hole 54. The hole 54 is dimensioned with respect to the joining element 6d such that a gap 56 is present between the wall of the hole 54 and the joining element 6d. Therefore material of the lower workpiece 4 which has been displaced during the joining operation may flow into the gap 56. Also in this case the volume of the gap 56 is chosen such that the gap 56 is substantially filled by the displaced material.

We claim:

1. A method of joining at least two workpieces in abutment to each other by means of a joining element wherein said joining element, during a joining process, is driven so as to perform rotational and translational movements in order to be moved through a first workpiece of said at least two workpieces and into a second workpiece thereof without full penetration of said second workpiece so as to provide for an integral one-piece joint between said joining element and said second workpiece as a result of friction caused by said movements of said joining element while the workpieces remain in abutment to each other.

2. The method of claim 1 wherein a geometrical shape of said joining element and/or materials of said joining elements and said at least two workpieces and/or predetermined process parameters of the joining process are selected such that the workpieces remain in abutment to each other during the joining process.

3. The method of claim 2 wherein said predetermined process parameters of the joining process comprise the speed of said rotational and translational movements of said joining element and a joining force exerted upon said joining element during the joining process.

4. The method of claim 1 wherein said workpieces are retained in abutment to each other during the joining process by a clamping device.

5. The method of claim 4 wherein said at least two workpieces are supported by an anvil during the joining process.

6. The method of claim 1 wherein said integral one-piece joint between said joining element and said second workpiece comprises a spin welding joint.

7. The method of claim 1 which further comprises providing a friction joint between said joining element and said second workpiece during the joining process.

8. The method of claim 1 which further comprises providing a positive interlocking joint between said joining element and said first workpiece during the joining process.

9. The method of claim 8 which further comprises providing a friction and/or integral one-piece joint between said joining element and said first workpiece.

10. The method of claim 1 which further comprises providing a friction joint between surfaces of said at least two workpieces in abutment to each other.

11. The method of claim 1 which further comprises providing an adhesive joint between surfaces of said at least two workpieces in abutment to each other.

12. The method of claim 1 wherein said joining element is caused to displace material of said first workpiece when said joining element is moved through said first workpiece.

13. The method of claim 1 wherein said first workpiece is provided with a hole in a joining area prior to the joining process.

14. The method of claim 1 wherein said at least two workpieces are made of different materials.

15. The method of claim 14 wherein said first workpiece is made of a relatively soft ductile material and said second material is made of harder high-strength material.

16. The method of claim 14 wherein said first workpiece is made of a relatively soft metal, in particular aluminium, and said second workpiece is made of a harder metallic material, in particular steel.

17. The method of claim 14 wherein said first workpiece is made of a plastic material, in particular a polymeric material, and said second workpiece is made of a metallic material.

18. The method of claim 1 wherein said joining element and said second workpiece are made of materials suited to be joined to form a spin welding joint.

19. The method of claim 18 wherein said joining element is made of a metallic material, in particular steel or aluminium.

20. The method of claim 1 wherein rotational movement of said joining element is performed at a speed of 5,000 to 30,000 rpm, in particular 10,000 to 25,000 rpm, preferably in the order of 23,000 rpm.

21. The method of claim 1 wherein translational movement of said joining element is performed at a relatively small joining force such that supporting said at least two workpieces in a direction opposite to said joining force is not necessary.

22. The method of claim 1 wherein said joining element, in a first phase, is moved into said at least two workpieces by simultaneous rotational and translational movement and the rotational movement of said joining element is abruptly terminated, and wherein said joining element, in a second phase directly following said first phase, is urged into an end position in said second workpiece by further translational movement thereof.

23. The method of claim 1 wherein said joining element is moved into an end position in said second workpiece by simultaneous rotational and translational movements in a single phase.

24. A joining element for joining at least two workpieces in abutment to each other, the joining element comprising a member which is at least partially of rotationally symmetrical or substantially rotational symmetrical shape, said member comprising a body portion of a cross-sectional area which increases in a predetermined direction so as to provide for a positive interlocking joint with a first workpiece of said at least two workpieces when it is moved through said first workpiece by rotational and translational movements.

25. The joining element of claim 24 which comprises a penetrating portion for penetrating into said at least two workpieces, said penetrating portion being of a cross-sectional area which increases in said predetermined direction.

26. The joining element of claim 25 wherein said penetrating portion has a tapered tip or a radiused tip or an annular edge.

27. The joining element of claim 24 which comprises a drive formation for being driven to perform rotational movements.

28. The joining element of claim 24 which is of a shape without enlarged head so as to be suited to be received completely in said at least two workpieces.

29. The joining element of claim 24 which has an enlarged head suited to engage an upper surface of said first workpiece.

30. The joining element of claim 29 wherein said enlarged head has a bottom side provided with a recess for receiving displaced material of said first workpiece.

31. The joining element of claim 24 which further comprises a functional element for performing an additional function, in particular a smooth or threaded bolt for mounting an additional part.

32. The joining element of claim 25 wherein said penetrating portion and said body portion have external surfaces each of which includes a constant or varying angle with a central axis of said joining element, a maximal angle of said penetrating portion being smaller than a minimal angle of said body portion.

33. The joining element of claim 32 wherein said external surfaces of said penetrating portion and said body portion are rotationally symmetrical smooth surfaces.

34. The joining element of claim 33 wherein said external surfaces of said penetrating and body portions each comprise conical surfaces.

35. The joining element of claim 32 wherein said external surfaces of said penetrating portion and said body portion are provided with one or a plurality of helical cutting edges.

36. The joining element of claim 35 wherein virtual envelopes of said helical cutting edges comprise conical surfaces.

37. The joining element of claim 32 wherein said constant or varying angle between the surface of said penetrating portion and the central axis of the joining element is between 20° and 50°, preferably in the order of 30°, and said constant or varying angle between the surface of said body portion and the central axis of the joining element is between 45° and 85°, preferably in the order of 75°.

38. The joining element of claim 37 wherein said external surfaces of said penetrating and body portions are connected to each other by a radiused surface.

39. The joining element of claim 32 wherein said penetrating portion has a sharp or radiused tip.

40. The joining element of claim 32 which further comprises an enlarged head provided with a drive formation comprising teeth at a side remote from said penetrating portion.

41. The joining element of claim 40 wherein said head has a central depression at a side remote from said penetrating portion for receiving a feed and drive tool adapted to exert a vacuum force upon said joining element.

42. A method of joining at least two workpieces in abutment to each other by means of a joining element wherein said joining element is driven so as to perform rotational and translational movements in order to be moved through a pre-manufactured hole of a first workpiece of said at least two workpieces and into said second workpiece without full penetration of said second workpiece so as to provide for an integral one-piece joint between said joining element and said second workpiece due to friction as a result of said rotational and translational movements while said workpieces remain in abutment to each other, said pre-manufactured hole of said second workpiece being dimensioned with respect to said joining element such that there is a gap between a circumferential wall of said hole and said joining element to receive material of said second workpiece which is displaced during the joining process.
